(19) United States
(12) Patent Application Publication
(10) Pub. No.: US 2023/0121114 A1
(43) Pub. Date: Apr. 20, 2023

(54) Energy Management Method and Energy Management System

(71) Applicant: Siemens Aktiengesellschaft, München (DE)

(72) Inventors: Thomas Baumgärtner, Erlangen (DE); Sebastian Thiem, Neustadt an der Aisch (DE); Lisa Wagner, Fürth (DE)

(73) Assignee: Siemens Aktiengesellschaft, München (DE)

(21) Appl. No.: 17/911,234

(22) PCT Filed: Jan. 14, 2021
(86) PCT No.: PCT/EP2021/050620

§ 371 Date: Dec. 26, 2022

(30) Foreign Application Priority Data
Mar. 17, 2020 (DE) 10 2020 203 407.9

(51) Int. Cl. H02J 3/00; H02J 7/00; H02J 7/35; H02J 3/38; H02J 3/46

(52) U.S. Cl. CPC H02J 3/003; H02J 7/0048; H02J 7/35; H02J 3/381; H02J 7/00306; H02J 3/466; H02J 2300/24

(57) ABSTRACT

Various embodiments of the teachings herein include an energy management method for an energy system. The method may include: calculating a power prediction for use of an energy storage unit of the energy system for a time range; and determining, on the basis of the calculated power prediction, an externally usable partial storage capacity of the energy storage unit. The partial storage capacity according to the power prediction is not used by the energy system within the time range. The determined partial storage capacity is provided for use external to the energy system.

### CROSS-REFERENCE TO RELATED APPLICATIONS

This application is a U.S. National Stage Application of International Application No. PCT/EP2021/050620 filed Jan. 14, 2021, which designates the United States of America, and claims priority to DE Application No. 10 2020 203 407.9 filed Mar. 17, 2020, the contents of which are hereby incorporated by reference in their entirety.

### TECHNICAL FIELD

The present disclosure relates to energy systems. Various embodiments include methods and/or systems for energy management.

### BACKGROUND

Energy management methods are used for the predictive and maximally efficient operation of energy systems. An energy management system typically controls or regulates installations of the energy system in accordance with a pre-calculated power prediction. In particular, energy management, i.e. an energy management method or energy management system, may enable the associated energy system to be integrated into a local energy market.

Via a local energy market, energy systems can exchange and trade locally produced energy among one another, in particular electrical energy (electricity). In this context, the local energy market, through its decentralized design, enables the locally produced energy to be efficiently matched with the local energy consumption. Thus, a local energy market is particularly advantageous in the context of renewable energies, which are typically produced locally. In principle, energy systems can be categorized into energy consumers (consumers), energy converters, and prosumers, which can both consume and supply or produce energy. In this context, energy converters can be referred to colloquially as energy generators (generators), wherein the term generation refers to the form of energy provided, for example electricity in the case of electricity generators.

Technically, a local energy market is realized by a control platform, which can also be called an energy market platform. The control platform coordinates or controls the energy exchanges between the energy systems based on offers that the energy systems submit to the control platform in advance. These offers, which include technical data relating to the energy system or its installations, can be determined by the energy management system and submitted to the local energy market.

Such a local energy market is described, for example, in document EP 3518369 A1. Known energy management systems submit aggregated offers to the local energy market only with respect to a grid connection of the energy system. This does not allow the whole flexibility, for example in the form of energy storage units, to be used by the local energy market.

### SUMMARY

The teachings of the present disclosure include energy management systems which enable an improved utilization of energy storage units of an energy system. For example, some embodiments include an energy management method for an energy system, wherein a power prediction (43) for use of an energy storage unit of the energy system for a time range (12) is calculated, characterized in that, on the basis of the calculated power prediction (43), at least one externally usable partial storage capacity (42) of the energy storage unit is determined, which partial storage capacity, according to the power prediction (43), is not used by the energy system within the time range (12), the determined partial storage capacity (42) being provided for use external to the energy system.

In some embodiments, the partial storage capacity (42) comprises a charge storage capacity SOC₊ and a discharge storage capacity SOC₋, wherein the charge storage capacity SOC₊ is used for externally charging the energy storage unit, and the discharge storage capacity SOC₋ is used for externally discharging the energy storage unit.

In some embodiments, the charge storage capacity SOC₊ and the discharge storage capacity SOC₋ are determined depending on the initial state of charge (1) of the energy storage unit with respect to the time range (12).

In some embodiments, the external use of the energy storage unit is such that the final state of charge (2) of the energy storage unit with respect to the time range (12) is equal to the initial state of charge (1) with respect to the time range (12).

In some embodiments, the external use of the energy storage unit is such that the state of charge within the time range (12) is either below or above the initial and final states of charge (1, 2) with respect to the time range (12).

In some embodiments, the charge storage capacity SOC₊ is determined by SOC₊=1−SOCₘₐₓ, wherein SOCₘₐₓ indicates the maximum state of charge of the energy storage unit within the time range (12), and/or the discharge storage capacity SOC₋ is determined by SOC₋=1−SOCₘᵢₙ, wherein SOCₘᵢₙ indicates the minimum state of charge of the energy storage unit within the time range (12).

In some embodiments, the external use of the energy storage unit is such that a maximum number of cycles of the energy storage unit with respect to the time range (12) is not exceeded.

In some embodiments, the time range (12) is determined by means of the power prediction (43), wherein the determination is made under the condition that the energy storage unit is not used by the energy system within the time range (12).

In some embodiments, the partial storage capacity (42) is submitted to a local energy market platform in the form of a storage offer for external use by further energy systems.

In some embodiments, the external use, in particular with regard to the charging power and discharging power of the energy storage unit, is determined and specified by the local energy market platform within the time range (12).

As another example, some embodiments include an energy management system for an energy system, which is configured to calculate a power prediction (43) for use of an energy storage unit of the energy system for a time range (12), characterized in that the energy management system is designed, on the basis of the calculated power prediction (43), to determine at least one externally usable partial storage capacity (42) of the energy storage unit, which partial storage capacity, according to the power prediction (43), is not used by the energy system within the time range (12), and to provide the determined partial storage capacity (42) for use external to the energy system.

### BRIEF DESCRIPTION OF THE DRAWINGS

Further advantages, features, and details of the teachings herein can be found in the following description of exemplary embodiments and based on the drawings. In the drawings, schematically in each case:

FIG. 1 shows a diagram of a total power prediction, generation predictions of two photovoltaic systems and power prediction of a battery storage unit incorporating teachings of the present disclosure; and

FIG. 2 shows a diagram for determining a partial storage capacity of an energy storage unit available for external use incorporating teachings of the present disclosure; and

Similar, identical, or functionally equivalent elements may be labelled with the same reference signs in one of the figures or in the figures.

### DETAILED DESCRIPTION

In the energy management methods described herein for an energy system, a power prediction, in particular a load prediction, is calculated for the use of an energy storage unit of the energy system for at least one time range. In some embodiments, on the basis of the calculated power prediction, at least one externally usable partial storage capacity of the energy storage unit is determined, which partial storage capacity, according to the power prediction, is not used by the energy system within the time range, the determined partial storage capacity being provided for use external to the energy system. In this case, the term control includes regulation.

Energy systems typically comprise a plurality of components, in particular energy-related systems, such as energy conversion units, consumption units and/or storage facilities. In particular, the energy system is a multimodal energy system.

Multimodal energy systems are energy systems that generate and/or supply multiple forms of energy. In particular, a multimodal energy system provides one or more forms of energy to an energy consumer, such as a building, an industrial facility or private facilities, provided in particular by converting different forms of energy, by transporting different forms of energy and/or by stored forms of energy. In other words, the various forms of energy, such as heat, cold, or electrical energy, are coupled by means of the multimodal energy system with regard to their generation, supply and/or storage.

As installations, the energy system can comprise one or more of the following components: electricity generators, combined heat and power plants, in particular communal heating/power stations, gas boilers, diesel generators, heat pumps, compression refrigerating machines, absorption refrigerating machines, pumps, district heating networks, energy transfer lines, wind turbines or wind farms, photovoltaic systems, biomass plants, biogas plants, waste incinerators, industrial plants, conventional power plants and/or the like. The energy management methods described herein and/or one of its embodiments and/or one or more functions, features and/or steps of the method or its embodiments may be at least partially or completely computer-aided.

In some embodiments, at least part of the (total) storage capacity of the energy storage unit is released or made available for external use. This involves determining what portion of the storage capacity of the energy storage is used by the energy system and what portion is not used, within the time range. The unused portion is made available for external use, in particular for use externally to the energy system. As a result, the operation of the energy system is advantageously disrupted or affected as little as possible and remaining storage capacities of the energy storage unit can be used and thus exploited externally, for example by energy systems external to the energy system. In other words, the energy storage unit and the flexibility it provides can be better exploited.

To determine the partial storage capacity, i.e. to determine the portion of the storage capacity of the energy storage unit which is provided or can be provided externally, a power prediction of the energy storage unit is carried out by an energy management system incorporating teachings of the present disclosure. The power prediction indicates the temporal characteristic of the charging power or discharging power that is present in the energy storage unit, at least within the time range or within a further, typically longer time range.

According to the power prediction, which is provided, for example, for a future day, in particular for the next day, it is possible to determine for one or more time ranges the extent to which the energy storage unit will be used by the energy system, that is, charged or discharged. If, for example, the energy storage unit is to be charged up to a specific state of charge starting from an initial state of charge, the storage capacity remaining up to the maximum state of charge can be used for external charging. In some embodiments, the existing storage capacity can be discharged externally. In particular, the energy storage unit is not used by the energy system within the time range. As a result, the entire storage capacity of the energy storage unit can be made available externally or used externally for the specified time range. This is the case, for example, for an energy storage unit with a connected photovoltaic system, as in this case the energy storage unit is typically charged in the morning hours and discharged in the evening hours. In the meantime, i.e. within the time range, the storage capacity of the energy storage unit is made available externally.

The teachings of the present disclosure thus enable the greatest possible use of the energy storage system by energy-system-internal and energy-system-external use. For this purpose, the energy storage unit is divided virtually into a storage capacity used by the energy system and a storage capacity used externally (partial storage capacity).

In some embodiments, the methods and/or systems disregard the energy storage unit for the time range within the energy management method and therefore when calculating the load profile. Thus, the entire storage capacity could also be used externally. As a result, the charging and/or discharging of the energy storage unit would be controlled or regulated quasi-externally. However, this would typically degrade the operational efficiency of the energy system and thus of the energy management method. This would be the case, for example, if charging the energy storage unit would cause a maximum permissible peak power of the energy system, typically permitted on a monthly basis, to be exceeded, as an increased power price would then be incurred.

The energy management systems incorporating teachings of the present disclosure for an energy system is designed to calculate a power prediction for the use of an energy storage unit of the energy system for a time range. The energy management system is characterized in that it is also designed to determine, on the basis of the calculated power prediction, at least one externally usable partial storage capacity of the energy storage unit, which partial storage capacity, according to the power prediction, is not used by the energy system within the time range, the determined partial storage capacity being provided for use external to the energy system.

In some embodiments, the energy management system is particularly designed to exchange information or associated data sets with a local energy market platform, i.e. to submit information or data sets to the local energy market platform and/or to receive them from the energy market platform and/or process them. In particular, the energy management system for controlling or regulating installations of the energy system, in particular the energy storage unit, may be designed on the basis of information or data sets received from the energy market platform. The same and/or equivalent advantages and/or embodiments are obtained for the energy management methods incorporating teachings of the present disclosure.

A local energy market as used in this disclosure comprises at least one energy system with an energy management system.

In some embodiments, the partial storage capacity comprises a charge storage capacity SOC₊ and a discharge storage capacity SOC₋, wherein the charge storage capacity SOC₊ is used for externally charging the energy storage unit, and the discharge storage capacity SOC₋ is used for externally discharging the energy storage unit. This allows the time range of the external use (time range) of the energy storage unit to be extended. Furthermore, external charging as well as external discharging of the energy storage unit are made possible.

In some embodiments, the charge storage capacity SOC₊ and the discharge storage capacity SOC₋ are determined depending on the initial state of charge of the energy storage unit with respect to the time range. This may improve the ability to calculate the partial storage capacity intended for external use.

In some embodiments, the external use of the energy storage unit takes place in such a way that the final state of charge of the energy storage unit is equal to the initial state of charge with respect to the time range. In other words, in this case the charge storage capacity is also determined as a function of the initial and final states of charge. This further improves and optimizes the external use of the energy storage unit without disrupting the internal operation of the energy storage system.

In some embodiments, the external use of the energy storage unit takes place in such a way that the state of charge within the time range is either below or above the initial and final states of charge with respect to the time range. An operator of the energy storage unit suffers no disadvantage, in particular no cost disadvantage, due to the external use.

In some embodiments, the charge storage capacity SOC₊ is determined by SOC₊=1−SOCₘₐₓ, wherein SOCₘₐₓ indicates the maximum state of charge of the energy storage unit within the time range, and/or the discharge storage capacity SOC₋ is determined by SOC₋=1−SOCₘᵢₙ, wherein SOCₘᵢₙ indicates the minimum state of charge of the energy storage unit within the time range. In this case, the charge storage capacity or the discharge storage capacity depends on the initial and/or final state of charge. In other words, the charge storage capacity and discharge storage capacity are determined relative to the initial state of charge within the time range.

In some embodiments, the use external to the energy storage unit takes place in such a way that a maximum number of cycles of the energy storage unit with respect to the time range is not exceeded. The maximum permissible charges or discharges of the energy storage unit are not exceeded within the time range. The maximum permissible number of cycles can depend on the energy storage unit, in particular its type. Typically, battery storage units may be charged or discharged up to twice per day. In some embodiments, the energy management system or the energy management method observes the specified condition on the number of cycles. The maximum number of cycles can be transmitted to external energy systems which use the energy storage unit, for example.

Due to its aging, it may be advantageous for a battery storage unit to keep its state of charge (abbreviated to SOC) within the range of a specific state of charge. This information may be covered by the offers submitted to a local energy market. This means the time range of the external use and/or the partial storage capacity intended for the external use can be better determined.

Furthermore, exceeding certain states of charge, for example for certain lithium-ion battery storage units above 60 percent, leads to chemical rearrangement processes in the cells of the battery storage unit, which cause disproportionate aging. This can also be taken into account in the offers made to the local energy market.

In other words, it may be advantageous to keep an electrochemical energy storage unit, in particular a battery storage unit, within a defined and state of charge range from an aging point of view, even if it is used externally. This information can be submitted to a local energy market, for example in the form of a respective storage offer, and taken into account by the energy market.

In some embodiments, the time range is determined by means of the power prediction, wherein the determination is made under the condition that the energy storage unit is not used by the energy system within the time range. In other words, the time range(s) in which the energy storage unit is not used by the energy system at all is/are determined. This determined time range can include multiple time ranges that can be contiguous or non-contiguous. For example, an energy storage unit in a residential building is typically not used in the afternoon. This time range is determined from the power prediction. The full storage capacity of the energy storage unit is then provided for external use, i.e. in this case the partial storage capacity is the total storage capacity of the energy storage unit.

In some embodiments, the partial storage capacity is submitted to a local energy market platform in the form of a storage offer for external use by further energy systems. This means that the energy storage unit can be used in a local energy market, which is technically formed by the local energy market platform, by other energy systems participating in the local energy market. In particular, this will improve the efficiency of the local energy market, as it will be possible to better match local energy production with local consumption within the local energy market. This is the case because the energy storage unit provides flexibility with regard to energy production and its consumption within the local energy market.

In addition, it results in cost neutrality for the operator of the energy storage unit. A cost neutrality for the energy management with respect to the local energy market must be ensured so that there is no disadvantage for the energy system comprising the energy storage unit. For example, increased power costs incurred due to the external use of the energy storage unit by the local energy market are covered by the local energy market or absorbed by it. By issuing the storage offer, it is also possible to take advantage of more existing flexibility at a regional level. On the one hand, this improves the use of resources. On the other hand, flexibility can also enable an increased proportion of renewable energies in the regional energy system. Furthermore, an additional source of income for the energy management or the energy management system is formed by the remuneration for the external use of the energy storage system achieved by the local energy market. This can encourage the development of local energy storage units, which is technically advantageous, in particular with regard to renewable energy sources.

In some embodiments, the energy management or the energy management system could determine a worst-case price for the external use of the energy storage unit by the local energy market and specify it in the respective storage offer. In some embodiments, the energy management issues multiple storage offers for the energy storage unit with different durations and different prices for the external use of the energy storage unit, but which are mutually exclusive. Thus, the energy market should only implement one of the storage offers issued.

In some embodiments, the external use, in particular with regard to the charging power and discharging power of the energy storage unit, is determined and specified by the local energy market platform within the time range. In other words, the external use of energy storage unit, based on the information submitted from the energy management system to the local energy market platform, is taken into account by the matching algorithm of the local energy market. The information may include and/or be based on the power prediction or the time range or ranges. Typically, the information is submitted in the form of offers to the local energy market platform by the energy management system and/or the energy system. The local energy market platform uses the information submitted to determine the external use of the energy storage unit and submits this in turn to the energy system, in particular to the energy management system, for example in the form of a price signal. The local energy management system then controls or regulates the external use of the energy storage unit accordingly, e.g. it is charged or discharged accordingly.

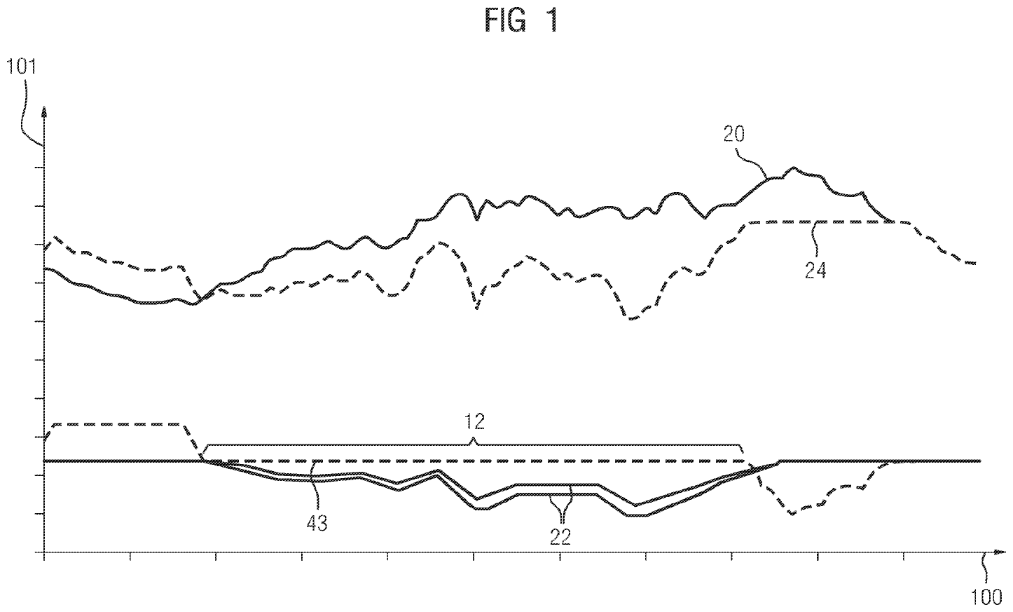

FIG. 1 shows a diagram of a total power prediction 20, generation predictions 22 of two photovoltaic systems, and a power prediction 43 of a battery storage unit. The energy system in this case comprises at least two photovoltaic systems and one energy storage unit, in particular a battery storage unit, such as a lithium-ion storage unit, in particular of an electric vehicle. For example, the energy system is a building, in particular a residential building.

On the abscissa 100 of the diagram shown, the time, in particular of one day, is plotted in arbitrary units. On the ordinate 101, a respective power is plotted in arbitrary units, for example in Watt. FIG. 1 shows an operating schedule for the energy system. The operating schedule is calculated by an energy management system incorporating teachings of the present disclosure.

The curve 20 corresponds to a total load predicted by the energy management system. In other words, the curve 20 is an overall power prediction for the energy system. The total power prediction 20 is also determined or calculated by the energy management system. The curves 22 illustrate the energy generation by the photovoltaic systems as predicted by the energy management system.

Curve 24 is a cost-optimal power prediction for the energy system calculated by the energy management system at a grid connection point of the energy system. Curve 43 is the power prediction with respect to the use of the energy storage unit internal to the energy storage system.

According to the power prediction 43 for the energy storage unit, i.e. according to the power in the energy storage unit, in particular in the battery storage unit, it is clear that it is being charged or loaded for the energy system in the morning hours (from midnight to 6:00 am). In other words, the energy storage unit is used by the energy system from midnight to 6:00 am. Furthermore, the energy storage unit is used by the energy system in the evening from 7:00 μm to 11:00 μm, in this case being discharged. In the time range 12 from 6:00 am to 7:00 pm, according to the calculated load prediction 43, i.e. according to the operating schedule or the optimal schedule calculation by the energy management system, the energy storage unit is not used by the energy system. This means that the energy storage unit is not required for the optimal operation of the energy system in the time range 12.

In some embodiments, the energy storage unit, in particular the battery storage unit, is fully charged in the morning hours (state of charge SOC equal to 1 or 100%) and is not discharged again until the evening hours (from about 8:00 pm) (SOC equal to 0.7). In the time range 12, the state of charge remains constant at 1 or 100% in line with the power prediction 43.

In some embodiments, the energy storage unit is therefore used by other energy systems within a local energy market for the time period 12. In this case, the full storage capacity of the energy storage unit is available for this external use in the time range 12. This means that a storage capacity offer for the time range 12 from 6:00 am to 8:00 pm can be submitted to the local energy market platform. If, as is the case here, the state of charge of the energy storage unit in the time range 12 is equal to 1, then the energy storage unit must first be discharged externally. The energy storage unit can then be externally charged. At the end of the time range 12, the state of charge should be the same as the initial state of charge with respect to external use, i.e. in this case at around 8:00 pm it has the value 1 again.

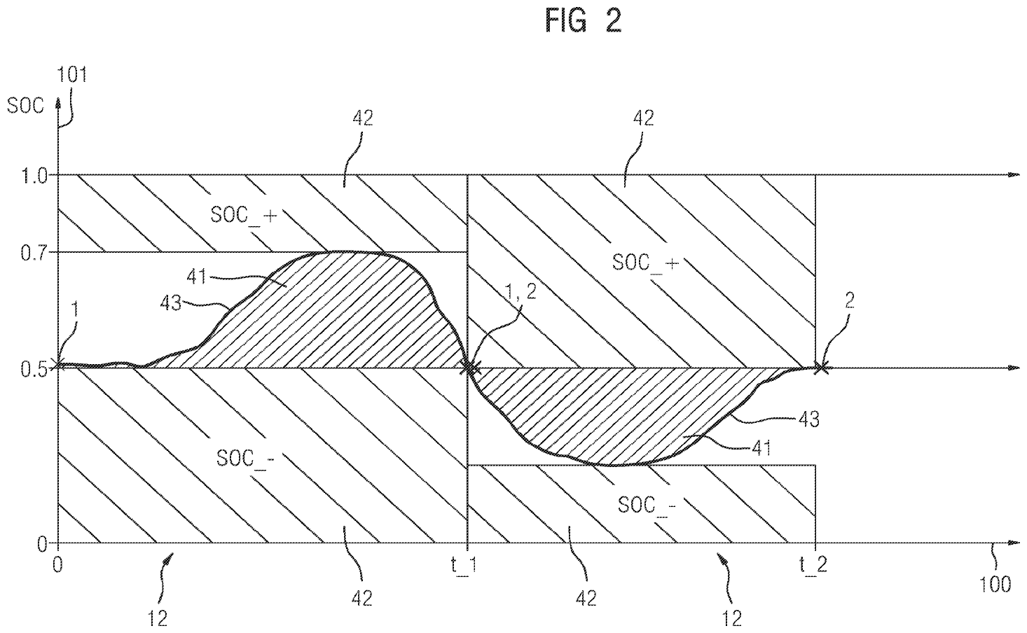

FIG. 2 shows a diagram for determining a partial storage capacity 42 of an energy storage unit available for external use. On the abscissa 100 of the diagram shown, the time, in particular of one day, is plotted in arbitrary units. The state of charge SOC of the energy storage unit is plotted on the ordinate 101. The state of charge is dimensionless, with a value of 1 (100%) indicating a full charge of the energy storage unit and a value of 0 (0%) indicating a complete discharge of the energy storage unit. In this case, the difference in value between two states of charge corresponds to a storage capacity.

In this exemplary embodiment, the partial capacities 42 are provided for external use by a local energy market. Two time ranges 42 are shown, which are consecutive in time and in which the energy storage unit is in principle available for external use. For example, at the beginning of the first of the two time ranges 12, the energy storage unit has an initial state of charge 1 of 0.5 (50%). In this case, it is required that the final state of charge 2 of the energy storage unit at the end of the first time range 12 also has the value 0.5 (50%). In other words, periodic boundary conditions are provided with regard to the first time range 12 and with regard to the state of charge of the energy storage unit.

According to a power prediction 43 for the use of the energy storage unit internal to the energy storage system, which was determined by an energy management systems described herein, the energy storage unit is charged by the energy storage system from the state of charge 0.5 to a maximum state of charge 0.7 in the first time range 12. Thus, the partial capacities 42 (charge storage capacity SOC₊ and discharge storage capacity SOC₋) can be used externally within the first of the time ranges 12. The partial capacities 42 are indicated by the hatched areas.

As part of the provision for a local energy market, a storage offer with the state of charge 0.5 and corresponding maximum charging and discharging power is thus submitted to the local energy market for the first of the time periods 12. The top left hatched area is the relative state of charge for charging (SOL₊) and the bottom left hatched area is the relative state of charge for discharging (SOC₋) the energy storage unit. In this case, relative means the dependency on the initial state of charge 1 of the energy storage unit within the specified or determined time range 12. These hatched areas can be used by the local energy market for charging or discharging the energy storage unit.

The hatched area 41 directly below the power prediction 43 describes the scope SOC₋ that remains for the energy management or the energy management system to operate the energy storage unit. For the following second time range 12, the same procedure can be carried out, wherein in this case the curve of the state of charge 43, which was calculated by the energy management or energy management system, remains below the initial or final state of charge. in principle, SOC₊ can be determined by SOC₊=1−SOCₘₐₓ, wherein SOCₘₐₓ indicates the maximum state of charge of the energy storage unit within the time range 12, and/or the discharge storage capacity SOC₋ can be determined by SOC₋=1−SOCₘᵢₙ, wherein SOCₘᵢₙ indicates the minimum state of charge of the energy storage unit within the time range 12. It is therefore essential that the state of charge within the time range 12 is either below or above the initial and final states of charge 1, 2 with respect to the time range 12.

Although the teachings herein have been illustrated and described in greater detail by means of the exemplary embodiments, the scope of the disclosure is not restricted by the examples disclosed and other variations can be derived therefrom by the person skilled in the art without departing from the scope of protection.

### LIST OF REFERENCE SIGNS

1 initial state of charge
2 final state of charge
12 time range
20 total power prediction of the energy system
22 generation prediction
24 cost-optimal power prediction at the grid connection point
of the energy system
41 storage capacity used by the energy system
42 partial capacity
43 power prediction of the energy storage unit
100 abscissa
101 ordinate

1. An energy management method for an energy system, wherein a power prediction (43) for use of an energy storage unit of the energy system for a time range (12) is calculated, characterized in that, on the basis of the calculated power prediction (43), at least one externally usable partial storage capacity (42) of the energy storage unit is determined, which partial storage capacity, according to the power prediction (43), is not used by the energy system within the time range (12), the determined partial storage capacity (42) being provided for use external to the energy system.

2. The energy management method as claimed in claim 1, characterized in that the partial storage capacity (42) comprises a charge storage capacity SOC₊ and a discharge storage capacity SOC₋, wherein the charge storage capacity SOC₊ is used for externally charging the energy storage unit, and the discharge storage capacity SOC₋ is used for externally discharging the energy storage unit.

3. The energy management method as claimed in claim 2, characterized in that the charge storage capacity SOC₊ and the discharge storage capacity SOC₋ are determined depending on the initial state of charge (1) of the energy storage unit with respect to the time range (12).

4. The energy management method as claimed in any one of the previous claims, characterized in that the external use of the energy storage unit is such that the final state of charge (2) of the energy storage unit with respect to the time range (12) is equal to the initial state of charge (1) with respect to the time range (12).

5. The energy management method as claimed in any one of the preceding claims, characterized in that the external use of the energy storage unit is such that the state of charge within the time range (12) is either below or above the initial and final states of charge (1, 2) with respect to the time range (12).

6. The energy management method as claimed in any one of claims 2 to 5, characterized in that the charge storage capacity SOC₊ is determined by SOC₊=1− SOCₘₐₓ, wherein SOCₘₐₓ indicates the maximum state of charge of the energy storage unit within the time range (12), and/or the discharge storage capacity SOC₋ is determined by SOC₋=1−SOCₘᵢₙ, wherein SOCₘᵢₙ indicates the minimum state of charge of the energy storage unit within the time range (12).

7. The energy management method as claimed in any one of the previous claims, characterized in that the external use of the energy storage unit is such that a maximum number of cycles of the energy storage unit with respect to the time range (12) is not exceeded.

8. The energy management method as claimed in any one of the previous claims, characterized in that the time range (12) is determined by means of the power prediction (43), wherein the determination is made under the condition that the energy storage unit is not used by the energy system within the time range (12).

9. The energy management method as claimed in any one of the previous claims, characterized in that the partial storage capacity (42) is submitted to a local energy market platform in the form of a storage offer for external use by further energy systems.

10. The energy management method as claimed in claim 9, characterized in that the external use, in particular with regard to the charging power and discharging power of the energy storage unit, is determined and specified by the local energy market platform within the time range (12).

11. An energy management system for an energy system, which is configured to calculate a power prediction (43) for use of an energy storage unit of the energy system for a time range (12), characterized in that the energy management system is designed, on the basis of the calculated power prediction (43), to determine at least one externally usable partial storage capacity (42) of the energy storage unit, which partial storage capacity, according to the power prediction (43), is not used by the energy system within the time range (12), and to provide the determined partial storage capacity (42) for use external to the energy system.
